(19) United States
(12) Patent Application Publication
(10) Pub. No.: US 2017/0034614 A1
(43) Pub. Date: Feb. 2, 2017

(54) APPARATUSES AND METHODS FOR IMPROVING OPERATION OF EARPHONES

(71) Applicant: Brian Harless, Fishers, IN (US)

(72) Inventor: Brian Harless, Fishers, IN (US)

(21) Appl. No.: 15/221,225

(22) Filed: Jul. 27, 2016

Related U.S. Application Data
(60) Provisional application No. 62/197,240, filed on Jul. 27, 2015.

(51) Int. Cl. H04R 1/10; H04R 3/04

(52) U.S. Cl. CPC H04R 1/1083; H04R 3/04; H04R 2460/01

(57) ABSTRACT

Apparatuses and methods for adapting earphone and microphone devices to operate with an aircraft communication system are disclosed. Embodiments include an adapter with a connector (e.g., a 3.5 mm S4 connector) for connecting to an off-the-shelf commercial ear phone and microphone system and connectors for connecting the adapter to an aircraft's communication system (e.g., a 6.5 mm PJ-055 connector and a 5.25 mm PJ-068 connector). Embodiments include a sound attenuator that attenuates noise in the signal from the aircraft communication system and transmits the attenuated signal to a user's earphone, such as an ANR earphone. Some embodiments include a sound attenuator that attenuates noise in the user's microphone channel. Still further embodiments include amplifiers in the microphone channel, the earphone channel, or both. Some embodiments include a device that manually or automatically selects the level of sound attenuation and/or amplification based on ambient noise.

This application claims the benefit of U.S. Provisional Application No. 62/197,240, filed Jul. 27, 2015 the entirety of which is hereby incorporated herein by reference.

### FIELD

Embodiments of the present disclosure relate generally to adapters for connecting earphones (e.g., in-ear earbuds and over-the-ear headphones) to an aircraft's communication system. Particular embodiments relate to adapters for connecting earphones to an aircraft's communication system and improving the performance of the earphones (e.g., earphones with active noise reduction capabilities) to an aircraft's communication system.

### BACKGROUND

Early model aircraft headsets transmitted audio information to an aircrew member (e.g., a pilot) using over-the-ear headphones with speakers housed within an ear piece insulated with foam or other sound absorbing material to attenuate background aircraft/cockpit noise levels for the aircrew member. These early systems were incorporated into headsets worn over the top of the aircrews' heads and were typically heavy and uncomfortable. A later generation ear piece included active noise reduction (ANR) to actively attenuate background noise heard by the aircrew. Although these later generation ear pieces improved performance, they were incorporated into headsets that were expensive and similarly heavy and cumbersome to wear. It was realized by the inventor of this current disclosure that improvements in the wearability and/or performance of aircraft communication devices for aircrew were needed. Certain features of the present disclosure address these and other needs, and provide other important advantages.

### SUMMARY

Embodiments of the present disclosure provide an improved ADAPTER for connecting active noise reduction (ANR) earphones (e.g., earbuds) to an aircraft's communication system.

Additional embodiments of the present disclosure provide apparatuses and methods for enhancing the performance of earphones (e.g., ANR earphones) for use in aircraft.

Further embodiments provide an apparatus that connects an earphone (e.g., an earbud), which may include active noise reduction (ANR) circuitry, to a standard aircraft communication system, e.g., the aircraft's radio, audio, inner cockpit communication system, etc., allowing the aircrew member to communicate over the radio, such as to air traffic control, or to individuals within the same plane, such as another crew member.

This summary is provided to introduce a selection of concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is a schematic representation of an adapter according to one embodiment of the present disclosure.

FIG. 2 is a schematic representation of an adapter according to another embodiment of the present disclosure.

FIG. 3 is a schematic representation of integrated circuit noise filter according to one embodiment of the present disclosure.

FIG. 4 is a block diagram of the circuitry in an adapter according to one embodiment of the present disclosure.

FIG. 5 is a schematic representation of an adapter depicting a number of alternate embodiments of the present disclosure.

FIG. 6 is a top perspective view of a printed circuit board (PCB) used in an adapter according to another embodiment of the present disclosure.

FIG. 7 is a bottom perspective view of the PCB depicted in FIG. 6.

FIG. 8 is a schematic diagram of the amplifier and noise filter included in the PCB of FIG. 6.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

Embodiments of the present disclosure include an adapter that allows an aircrew member (pilot, etc.) to connect off-the-shelf, commercial earphone and microphone system (e.g., in-ear active noise reduction (ANR) earbuds with a microphone in the cord) to an aircraft's communication system. The adapter allows an aircrew to communicate with other personnel within the aircraft through the aircraft's inner-aircraft communication system or with controllers or other personnel outside of the aircraft using the aircraft's radio. At least one embodiment of the disclosure includes an adapter that facilitates connection of off-the-shelf earphones (such as those that may be bought at Best Buy®, Target®, WalMart®, etc.) which have one type of physical connector (e.g., a 3.5 mm, 4-lead connector that connects to an iPhone or similar device), to the communication system of an aircraft, which has a different physical connector (e.g., a 6.35 mm PJ-055 or a 5.25 mm PF-068 connector). The aircraft communication system to which the adapter connects is the communication system built into an aircraft the pilots use to talk with themselves, air traffic control, and other aircraft.

In addition to allowing the physical connection of differently sized plugs, embodiments may also include one or more noise filtering (which may also be referred to as noise attenuating) and/or amplification circuits to enhance the operational capabilities of the off-the-shelf earphones, and in particular when connected to the aircraft and used in a noisy aircraft environment. While the adapter can be used with any type of earphones, certain embodiments of the adapter have particular applicability to connecting off-the-shelf ANR earphones to an aircraft communication system. The additional filters and/or amplifiers contained within the adapter improve the performance and enhance the ability of the ANR earphones to operate with the aircraft communication system and within the noisy environment of an aircraft cockpit.

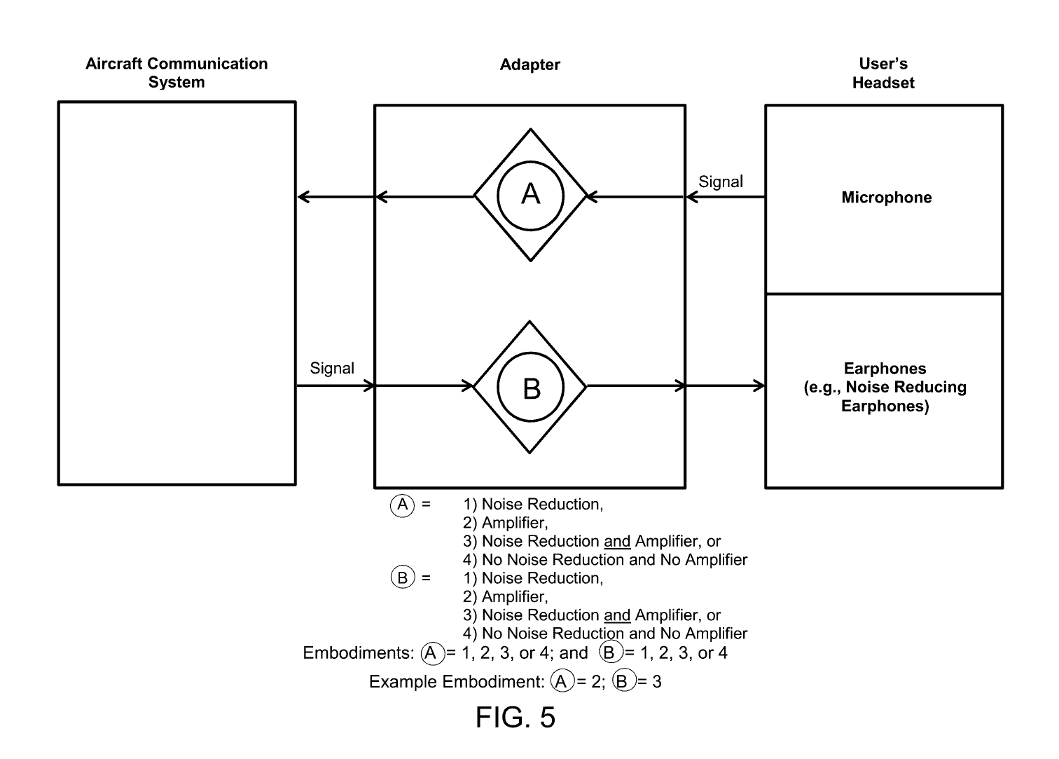

In at least one example embodiment, the adapter incorporates a noise filter to enhance the performance of the ANR earphones when connected to the aircraft communication system. One example adapter serves as a conduit for passing (a) unmodified signals from the aircraft communication system to the operator's earphones and (b) unmodified signals from the operator's microphone to the aircraft communication system. However, other example embodiments of the present disclosure include noise filters to filter noise in (a) the signals from the aircraft communication system to the operator/wearer's earphones and/or (b) the signals from the operator/wearer's microphone to the aircraft communication system. In addition to, or in place of, one or more noise filters, amplifiers may also be used to amplify the above-mentioned (a) and/or (b) signals. (See, e.g., FIG. 5).

In at least one embodiment, the noise filter attenuates noise (e.g., white noise) below 1500 Hz, while in other embodiments, the noise filter attenuates noise (e.g., white noise) in the 500-1500 Hz range.

The noise filter can be configured and adapted to filter specific background noise, such as noise prevalent in an aircraft cockpit or passenger compartment. For example, the noise level of a cockpit (which may range from 200 Hz to 3,000 Hz) can be recorded and various noise peaks, such as those that fall within the range of normal spoken words (e.g., in the range of 200 Hz to 2,700 Hz) for example, can be identified and filters used to reduce the noise either in these specific peaks or across broader frequency ranges. Using filters to reduce cockpit noise can have a substantial beneficial effect when filtering signals emanating from a user's microphone as well as filtering signals emanating from the aircraft communication system.

Still further, noise typically occurring in transmitted communications, such as when an aircrew is listening to a radio voice communication, can also be identified and filters used to filter out this noise in some embodiments. Using filters to reduce noise in radio voice communications can have a substantial beneficial effect when filtering signals emanating from the aircraft communication system as well as filtering a user's microphone.

In still other embodiments, an amplifier can be used to amplify signals traveling from the aircraft communication system to the user's earphone and/or from the user's microphone to the aircraft communication system. Certain embodiments selectively amplify frequencies in the range of normal spoken voice, such as in the 200 Hz to 3,000 Hz range.

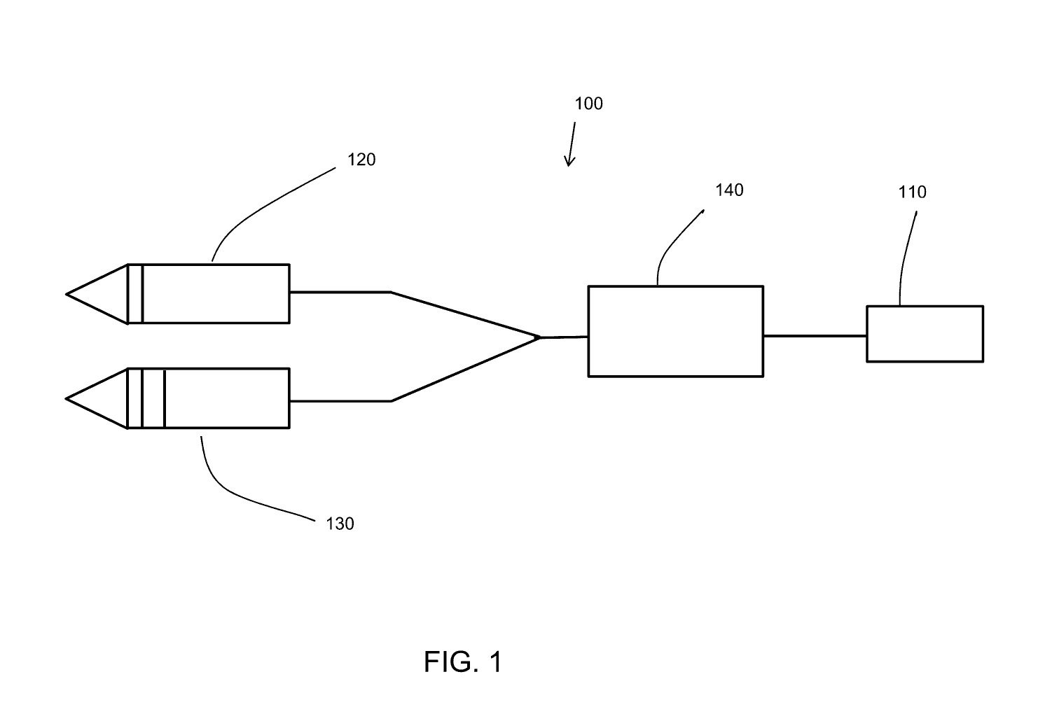

Depicted in FIG. 1 is an adapter 100 according to one embodiment of the present disclosure. The adapter 100 includes a connector 110 (e.g., a 3.5 mm female connector, which in some embodiments is a four (4) lead connector) that receives a male plug from an off-the-shelf headset that is not configured for use in an aircraft. Connector 110 is connected to two male connectors 120 and 130 configured and adapted to connect to an aircraft's communication system. In at least one embodiment, one of the male connectors (connector 120) is a 6.35 mm PJ-055 male plug and the other male connector (connector 130) is a 5.25 mm PJ-068 plug. In many aircraft systems the PJ-055 connector provides audio to the aircrew's ear pieces and the PJ-068 connector provides communication for the microphone. It should be appreciated that other embodiments include a single plug for connecting to the aircraft communication system, such as a 7.1 mm U-174 or U-93A type plug.

An optional noise filter 140 may be included between the connector(s) for the aircraft's communication system (connectors 120 and 130) and the connector(s) for the off-the-shelf earphone(s) and microphone system (connector 110). In at least one embodiment, noise filter 140 includes an integrated circuit configured and/or adapted to filter background noise from the user's microphone channel while performing little or no filtering to the earphone(s). Alternate embodiments include systems that filter both the microphone and earphone channels.

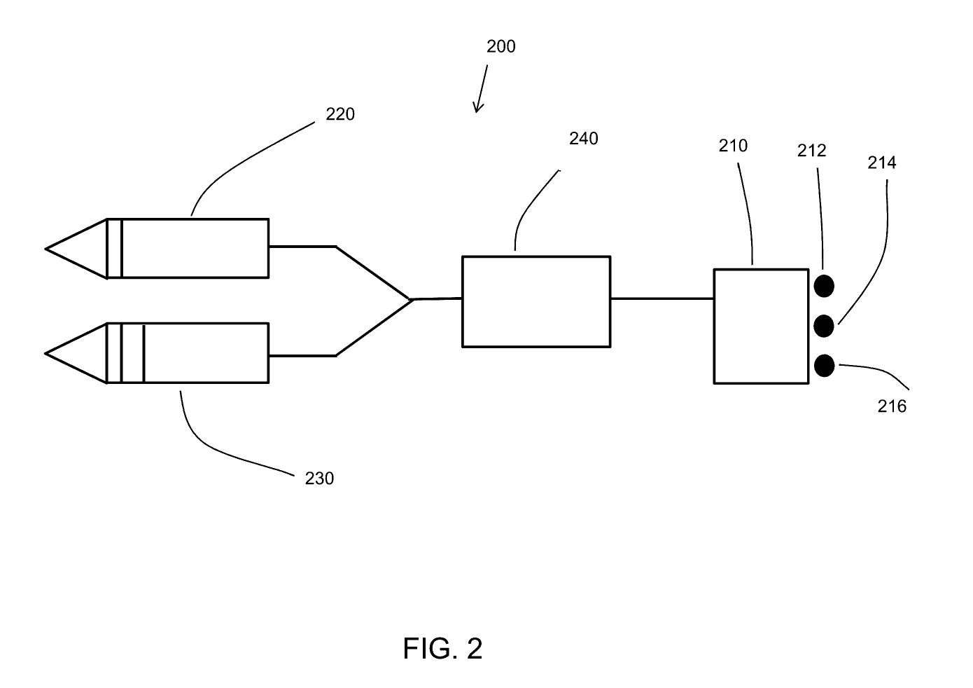

Depicted in FIG. 2 is an adapter 200 according to another embodiment of the present disclosure. Similar to the adapter depicted in FIG. 1, the adapter in FIG. 2 includes connectors for connecting the adapter to an aircraft's communication system, e.g., a 6.35 mm PJ-055 (connector 220) and 5.25 mm PJ-068 (connector 230) plugs. Adapter 200 also includes an optional noise filter 240 positioned between the connector(s) for the aircraft communication system (connectors 220 and 230) and the connector(s) for the earphone and microphone system (connector 210), one example being an off-the-shelf earphone and microphone system.

Connector 210 includes multiple, differently sized connectors allowing the user to connect the adapter to various types of off-the-shelf devices. For example, the right hand connector in FIG. 2 may include two 3.5 mm female connectors, each of which may be a four (4) lead connector, allowing the user to connect more than one electronic device to one another and/or to the aircraft's communication system. For example, in one embodiment a first 3.5 mm connector 212 is connected to both connectors for the aircraft's communication system, and a second 3.5 mm connector 214 is connected to only the headset channel, to which the first 3.5 mm connector 212 is also connected. Using this example embodiment, a user may plug an ear piece/microphone system into the first female 3.5 mm connector 212 and, for example, a music player into the second female 3.5 mm connector 214, allowing the user to listen to audio from the music player without the audio from the music player being transmitted through the aircraft's communication system via the microphone channel. Still another example embodiment of connector 210 includes a 2.5 mm (or alternately a 3.5 mm) female connector 216 allowing the user to connect a device with a 2.5 mm connector to at least the headset channel of the first 3.5 mm connector in the adapter depicted in FIG. 2. Additionally, a Bluetooth® circuit can be utilized to provide wireless connection to above said devices.

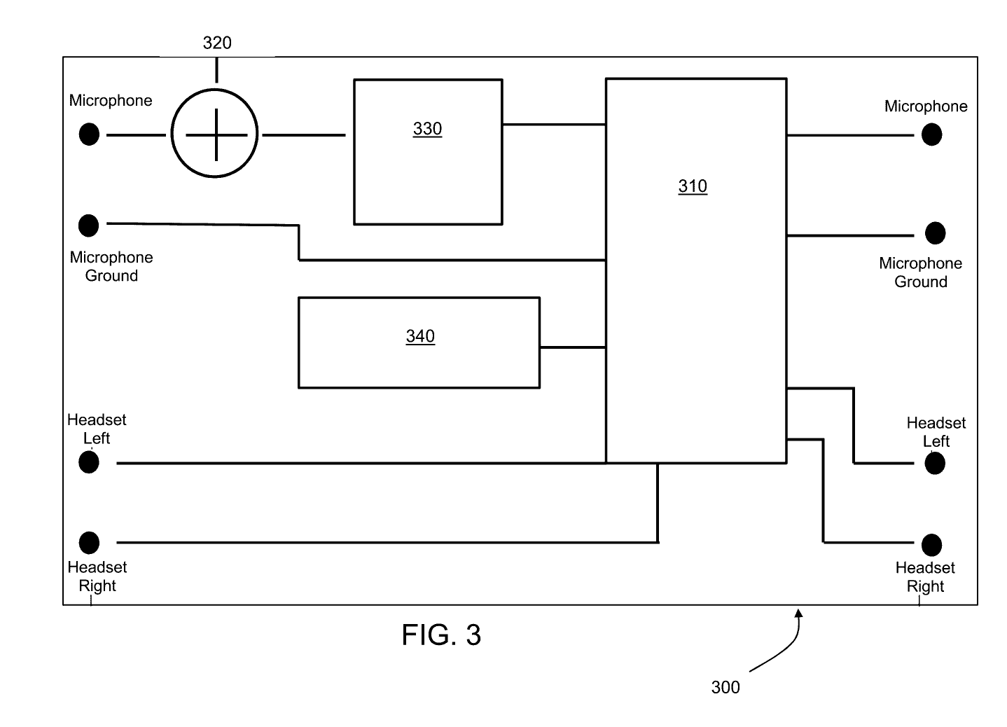

FIG. 3 depicts an integrated circuit 300 according to one embodiment of the present disclosure. Integrated circuit 300 includes a noise attenuator 310, which may be connected to one or more of the microphone channel, the headset left channel, and the headset right channel. Noise attenuator 310 may also include an amplifier and/or a processor for analyzing cockpit noise levels from a microphone (either from the user's headset microphone or a microphone included with the adapter of the present disclosure) for one or more of the microphone channel, the headset left channel, and the headset right channel. Integrated circuit 300 optionally includes a noise adjust switch 320, which may be used to manually select the amount of filtering used by noise attenuator 310. In one example, switch 310 has settings for high, medium, and low cockpit noise levels. Switch 310 adjusts the amount and/or type of noise filtering conducted by noise attenuator 310.

Integrated circuit 300 may also include an additional noise filter 330 on the microphone channel, which can add additional filtering to the microphone channel. Noise filter 330 can receive commands from noise adjust switch 320, or it can be a passive in-line filter to add additional filtering to the microphone channel.

Some embodiments of integrated circuit 300 include a wireless (e.g., Bluetooth®) capability with wireless circuit 340 for connecting to wireless devices, such as connecting to a music player wirelessly.

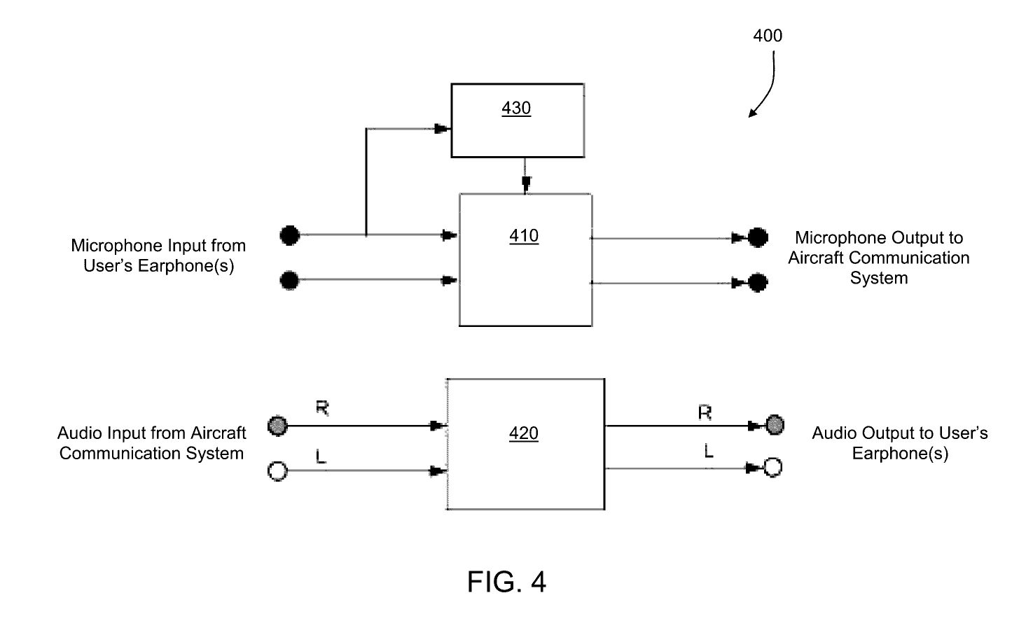

FIG. 4 depicts a block diagram of the circuitry in an adapter 400 according to one embodiment of the present disclosure. This circuitry is typically embodied in a printed circuit board (PCB). The PCB provides amplification of a microphone input signal, which typically comes from a user's microphone integrated into an earbud or headset, using microphone amplifier 410. The amplified microphone signal is then output to the aircraft's communication system. The microphone circuit may also have a noise attenuator to filter excessive noise (e.g., white noise below 1500 Hz), which may be optionally activated and deactivated with a switch. The switch may alternatively, or optionally, have a selection for different ambient (e.g., cockpit) noise levels, e.g., a two-position switch to select between loud and low ambient noise levels.

The PCB depicted in FIG. 4 also provides filtering via an audio pass through filter 420 for right and left audio signals input from the aircraft's communication system and output to the user's earphones. The PCB also provides an optional voltage regulator 430 to power the microphone amplifier circuitry. This power may be derived from the DC level riding on the microphone input channel.

Although FIG. 4 depicts both input channels for the amplifier and filter appearing on the left side of the diagram and the output appearing on the right side of the diagram, another way to display FIG. 4 is to place the aircraft communication system on, for example, the left side of the diagram with the user's earphone(s) on the other (right) side of the diagram, in which case the diagram with amplifier 410 would be reversed to place the output on the left hand side of the diagram.

Embodiments of the present disclosure are capable of operating effectively with or without a separate power source.

FIG. 5 is a schematic representation of an adapter depicting a number of alternate embodiments of the present disclosure. The microphone channel from the user's headset is received by processor (A) in the adapter before being transmitted by processor (A) to the aircraft communication system. The audio channel from the aircraft communication is received by processor (B) before being transmitted by processor (B) to the user's earphone(s). Each processor (A) or (B) may include noise reduction circuitry, amplification circuitry, both noise reduction circuitry and amplification circuitry, or neither noise reduction circuitry nor amplification circuitry. Various embodiments utilize various combinations of these features. One example embodiment utilizes an amplifier in processor (A) to amplify the signal from the user's microphone to the aircraft communication system and noise reduction and amplification circuitry in processor (B) to reduce noise and amplify the signal from the aircraft communication system to the user's earphone(s).

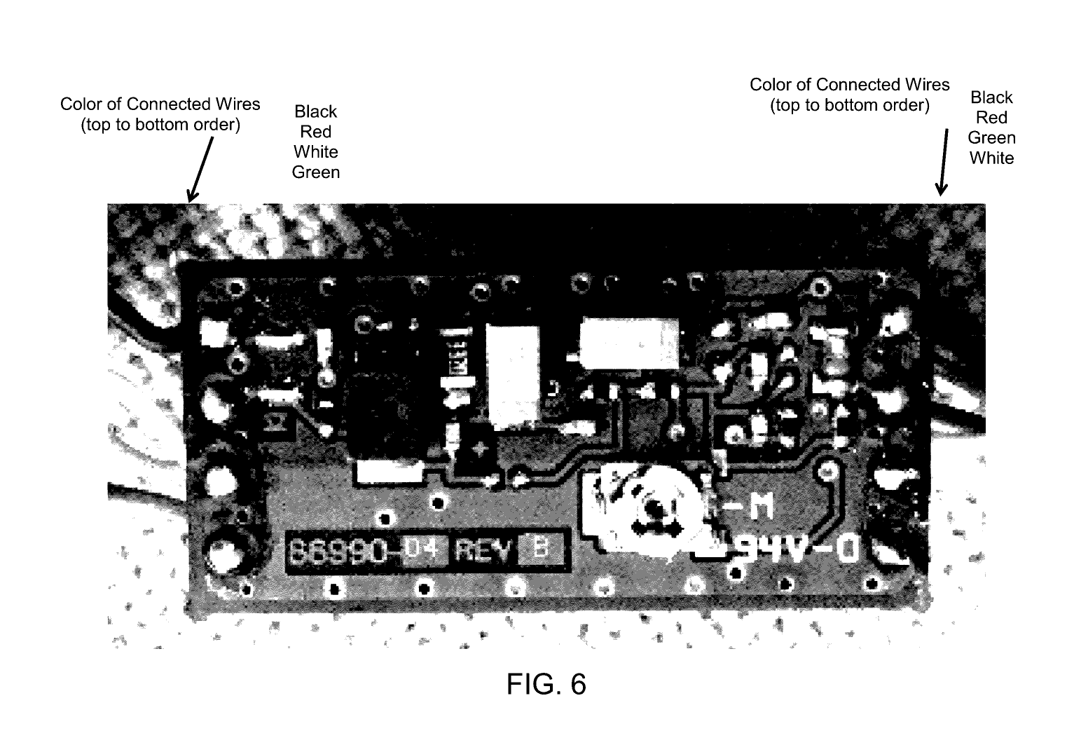

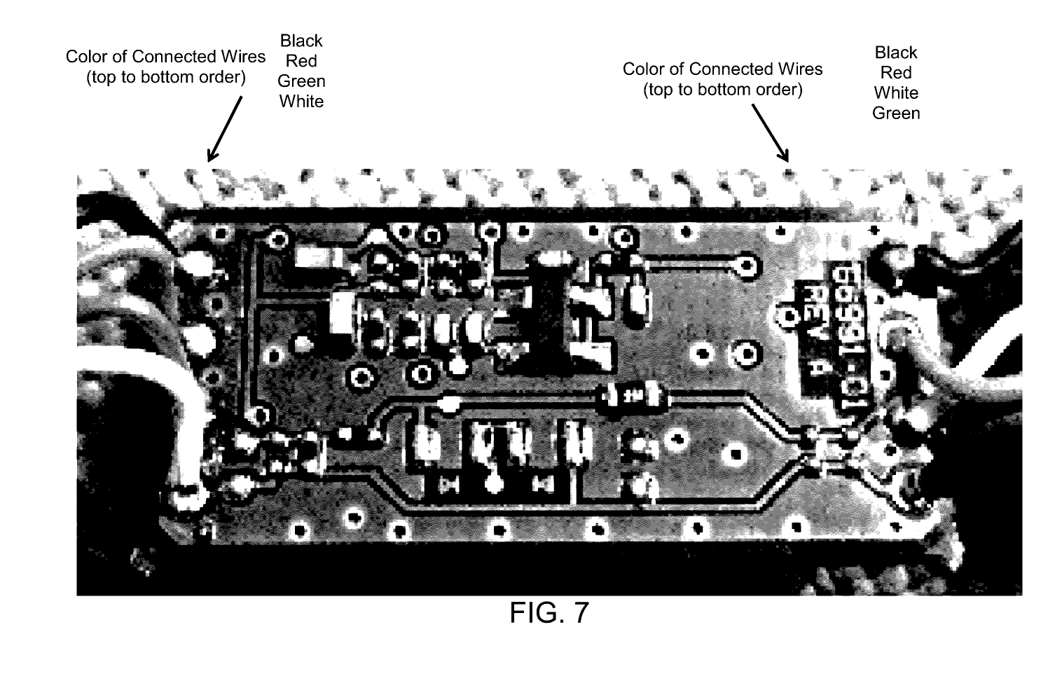

FIGS. 6 and 7 depict an integrated circuit design that may be used to filter noise and/or amplify signals with any embodiment described herein. The example integrated circuit depicted in the figures is a commercially available integrated circuit manufactured by Plantronics®, although other specific forms of integrated circuits that have features and functions similar to those described herein may be used with the embodiments described herein. The color of wiring depicted in FIGS. 6 and 7 is included to assist with the understanding of the integrated circuit and would be understood by a person with knowledge of the operation of such an integrated circuit.

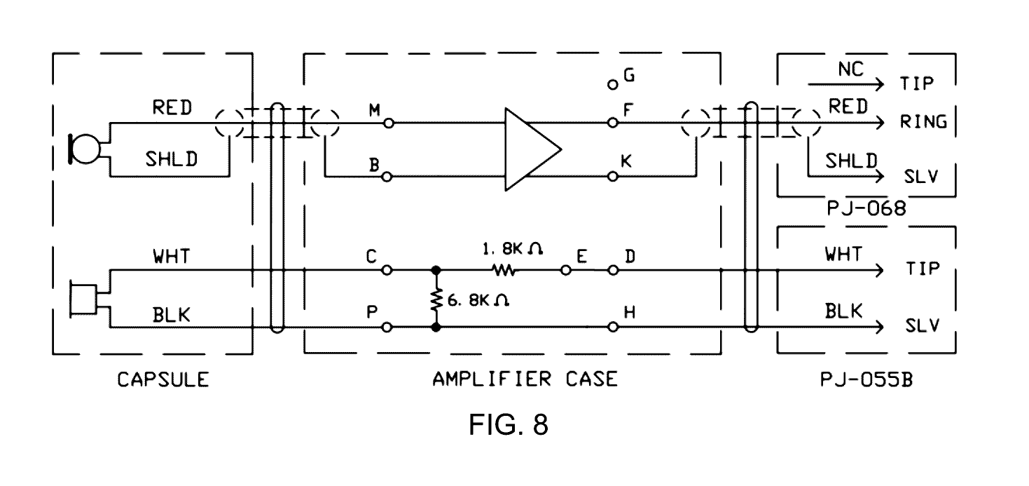

FIG. 8 depicts a schematic of an amplifier and noise filter for an adapter according to one embodiment of the present disclosure. The depicted schematic is for a commercially available amplifier and noise filter manufactured by Plantronics®, although other specific forms of amplifiers and noise filters that have features and functions similar to those described herein may be used with the embodiments described herein.

Still further embodiments include an adapter as described above with a cockpit noise level selection switch the operator/user can use to selectively change the level of noise filtering for the earphone and/or microphone channel based on the noise level in the cockpit. Still further embodiments of the adapter include a noise level detector (e.g., a microphone) that detects cockpit noise levels and automatically adjusts the additional noise filtering (which may take the form of selecting one of a plurality of preset noise filters) in the connector to the (a) headphone channel and/or (b) microphone channel.

Various embodiments of the present disclosure include:
i. A hand connectable and hand disconnectable adapter (e.g., an adapter that does not require tools to connect to or disconnect from) configured and adapted to connect one or more active noise reduction (ANR) earphones to an aircraft communication system, the adapter including a noise filtering circuit to filter noise in the channel that delivers audio data from the aircraft communication system to the operator/wearer's ANR earphone (described above as channel (a));
ii. A hand connectable and hand disconnectable adapter (e.g., an adapter that does not require tools to connect to or disconnect from) configured and adapted to connect an active noise reduction (ANR) earphone to an aircraft communication system, the adapter including a noise filtering circuit to filter noise in the channel that delivers audio data from the operator/wearer's microphone to the aircraft communication system (described above as channel (b));
iii. An adapter including noise filtering on both channels described above in items i and ii;
iv. An adapter as described in items i, ii, or iii above, further including an operator selectable switch for selecting the level of noise filtering (e.g., high, medium, low) to accommodate cockpits of different noise levels; and
v. An adapter as described in items i, ii, iii, or iv above, further including a cockpit noise sensor (microphone) to automatically detect cockpit background noise level and automatically select the appropriate noise filter for the headset and/or microphone channels based on the cockpit background noise.

Advantages realized by various embodiments include the ability to use existing and/or upgraded headsets/earphones and microphone systems with an aircraft's communication system. By allowing aircrew to purchase off-the-shelf headsets/earphones designed for commercial use with cell phones and/or audio music players, embodiments of the present disclosure allow aircrew to take advantage of the latest developments in earphone and/or microphone technology without waiting for the manufacturers of aviation headsets to do so, which has traditionally taken many years, by adapting these off-the-shelf devices for use in the cockpit and/or cabin. Since off-the-shelf earphones are typically less expensive than the aviation headsets, use of embodiments of the present disclosure can also result in a substantial cost savings while allowing users to take advantage of the latest advances in noise reduction earphones. The optional noise reduction device (e.g., an in-line processing chip) can be used to enhance the performance of the off-the-shelf earphone and/or microphone in, for example, the aviation environment, such as by reducing background noise in the headset/earphone and/or reducing background noise being transmitted over the radio or through the aircraft's communication system.

The noise filters/attenuators associated with the embodiments of the present disclosure can include specific frequency ranges that are not filtered or attenuated for safety purposes. For example, some embodiments incorporate noise filters/attenuators that either do not filter/attenuate frequencies corresponding to audible cockpit warning systems and signals, or only slightly filter/attenuate these frequencies.

By using embodiments of the present disclosure, a user can connect an off-the-shelf earphone (e.g., earbud) to an aircraft's communication system without modifying the off-the-shelf earphone's connector. When the user is finished using the off-the-shelf earphone with the aircraft's communication system, the user can simply unplug the earphone from the adapter and use the off-the-shelf earphone with another device, such as a phone or an MP3 player. Embodiments of the present disclosure allow for a single commercial earphone (e.g., earbud) system to be connected to an aircraft communication system and then disconnected and used for other purpose without additional modification.

Embodiments of this disclosure, e.g., the embodiment depicted in FIG. 1 have been able to achieve a noise reduction of approximately 45 db while in use, while systems not using the adapter with the sound attenuator have only been able to reduce noise by approximately 33 db while in use.

While an aircraft cockpit has been used as an example environment, the embodiments described herein can be utilized in other noisy environments, such as around various types of machinery, engines, construction sites, to name a few. The noise filtering circuitry can also be tuned for various environments as needed to improve performance.

Various aspects of different embodiments of the present disclosure are expressed in paragraphs A1, A2, and A3, as follows:

A1. One embodiment of the present disclosure includes an apparatus for connection of an earphone to an aircraft communication system, comprising: a first electrical connector configured and adapted to connect to an aircraft communication system; a second electrical connector configured and adapted to connect to an earphone; and a noise attenuator connected to the first and second electrical connectors, wherein the noise attenuator attenuates noise from a signal received from the aircraft communication system through the first electrical connector and transmits the filtered signal to an earphone through the second electrical connector.

A2. Another embodiment of the present disclosure includes a method, comprising the acts of: filtering an electronic signal emanating from an aircraft communication system; and transmitting filtered electronic information to an earphone.

A3. Another embodiment of the present disclosure includes a method, comprising: connecting a noise attenuator to a first electrical connector, the first electrical connector configured and adapted to hand connect to and hand disconnect from an aircraft communication system; and connecting the noise attenuator to a second electrical connector, the second electrical connector configured and adapted to hand connect to and hand disconnect from an earphone; wherein the noise attenuator is configured and adapted to attenuate noise in an electrical signal received from the first electrical connector and transmit the attenuated electrical signal to the second electrical connector

Yet other embodiments include the features described in any of the previous statements A1, A2 or A3, as combined with
(i) one or more of the previous statements A1, A2 or A3,
(ii) one or more of the following aspects, or
(iii) one or more of the previous statements A1, A2 or A3 and one or more of the following aspects:

Wherein the earphone is an active noise reduction earphone.

Wherein the noise attenuator is a passive noise filter.

Wherein the noise attenuator includes a plurality of passive noise filters and a selector, wherein the selector selectively connects and disconnects one or more of the passive noise filters from the first electrical connector or the second electrical connector.

A microphone connected to the selector, wherein the selector selectively connects and disconnects the one or more of the passive noise filters in response to signals received from the microphone.

Wherein the noise attenuator does not receive information from a microphone.

An amplifier connected to the first and second electrical connectors, wherein the amplifier amplifies audio signals from the aircraft communication system through the first electrical connector and transmits the amplified signal to an active noise reduction earphone through the second electrical connector.

A third electrical connector configured and adapted to connect to a user's microphone; a fourth electrical connector configured and adapted to connect to an aircraft communication system; and an amplifier connected to the third and fourth electrical connectors, wherein the amplifier amplifies audio signals from a user's microphone through the third electrical connector and transmits the amplified signal to the aircraft communication system through the fourth electrical connector

Wherein the second and third electrical connectors are portions of the same electrical plug or receptacle.

A second amplifier connected to the first and second electrical connectors, wherein the second amplifier amplifies audio signals from the aircraft communication system through the first electrical connector and transmits the amplified signal to an active noise reduction earphone through the second electrical connector.

Wherein the noise attenuator is connected to the third and fourth connectors, wherein the noise attenuator attenuates noise from a signal received from a user's microphone through the third electrical connector and transmits the filtered signal to the aircraft communication system through the fourth electrical connector.

Wherein the first electrical connector is hand connectable and hand disconnectable from the aircraft communication system, and the second electrical connector is hand connectable and hand disconnectable from the noise reduction earphones.

Wherein filtering and transmitting are performed by a signal filtering device.

Attaching by hand the signal filtering device to the aircraft communication system.

Attaching by hand the signal filtering device to the active noise reduction earphone.

Detaching by hand the signal filtering device from the aircraft communication system.

Receiving information about the ambient noise level in the aircraft associated with the aircraft communication system.

Adjusting signal filtering based on the ambient noise level information.

Wherein said adjusting is accomplished with input from a user.

Connecting a first amplifier to the first electrical connector and the second electrical connector, the first amplifier configured and adapted to amplify an electrical signal received from the first electrical connector and transmit the amplified electrical signal to the second electrical connector.

Connecting a second amplifier to a third electrical connector, the third electrical connector configured and adapted to hand connect to and hand disconnect from a microphone; and connecting the second amplifier to a fourth electrical connector, the fourth electrical connector configured and adapted to hand connect to and hand disconnect from an aircraft communication system; wherein the amplifier is configured and adapted to amplify an electrical signal received from the third electrical connector and transmit the amplified signal to a fourth electrical connector.

Wherein the second and third electrical connectors are portions of the same electrical plug or receptacle.

Reference systems that may be used herein can refer generally to various directions (e.g., upper, lower, forward and rearward), which are merely offered to assist the reader in understanding the various embodiments of the disclosure and are not to be interpreted as limiting. Other reference systems may be used to describe various embodiments, such as referring to the direction of projectile movement as it exits the firearm as being up, down, rearward or any other direction.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

What is claimed is:

1. An apparatus for connection of an active noise reduction earphone to an aircraft communication system, comprising:
a first electrical connector configured and adapted to connect to an aircraft communication system;
a second electrical connector configured and adapted to connect to an active noise reduction earphone; and
a noise attenuator connected to the first and second electrical connectors, wherein the noise attenuator
attenuates noise from a signal received from the aircraft communication system through the first electrical connector and
transmits the filtered signal to an active noise reduction earphone through the second electrical connector.

2. The apparatus of claim 1, wherein the noise attenuator is a passive noise filter.

3. The apparatus of claim 1, wherein the noise attenuator includes a plurality of passive noise filters and a selector, wherein the selector selectively connects and disconnects one or more of the passive noise filters from the first electrical connector or the second electrical connector.

4. The apparatus of claim 3, comprising:
a microphone connected to the selector, wherein the selector selectively connects and disconnects the one or more of the passive noise filters in response to signals received from the microphone.

5. The apparatus of claim 1, wherein the noise attenuator does not receive information from a microphone.

6. The apparatus of claim 1, comprising:
an amplifier connected to the first and second electrical connectors, wherein the amplifier amplifies audio signals from the aircraft communication system through the first electrical connector and transmits the amplified signal to an active noise reduction earphone through the second electrical connector.

7. The apparatus of claim 1, comprising:
a third electrical connector configured and adapted to connect to a user's microphone;
a fourth electrical connector configured and adapted to connect to an aircraft communication system; and
an amplifier connected to the third and fourth electrical connectors, wherein the amplifier amplifies audio signals from a user's microphone through the third electrical connector and transmits the amplified signal to the aircraft communication system through the fourth electrical connector

8. The apparatus of claim 7, wherein the second and third electrical connectors are portions of the same electrical plug or receptacle.

9. The apparatus of claim 7, comprising:
a second amplifier connected to the first and second electrical connectors, wherein the second amplifier amplifies audio signals from the aircraft communication system through the first electrical connector and transmits the amplified signal to an active noise reduction earphone through the second electrical connector.

10. The apparatus of claim 9, wherein the noise attenuator is connected to the third and fourth connectors, wherein the noise attenuator attenuates noise from a signal received from a user's microphone through the third electrical connector and transmits the filtered signal to the aircraft communication system through the fourth electrical connector.

11. The apparatus of claim 1, wherein the first electrical connector is hand connectable and hand disconnectable from the aircraft communication system, and the second electrical connector is hand connectable and hand disconnectable from the noise reduction earphones.

12. A method, comprising the acts of:
filtering an electronic signal emanating from an aircraft communication system; and
transmitting filtered electronic information to an active noise reduction earphone.

13. The method of claim 12, wherein said filtering and transmitting are performed by a signal filtering device, the method comprising:
attaching by hand the signal filtering device to the aircraft communication system; and
attaching by hand the signal filtering device to the active noise reduction earphone.

14. The method of claim 13, comprising:
detaching by hand the signal filtering device from the aircraft communication system.

15. The method of claim 12, comprising:
receiving information about the ambient noise level in the aircraft associated with the aircraft communication system; and
adjusting said filtering based on the ambient noise level information.

16. The method of claim 15, wherein said adjusting is accomplished with input from a user.

17. A method, comprising:
connecting a noise attenuator to a first electrical connector, the first electrical connector configured and adapted to hand connect to and hand disconnect from an aircraft communication system; and
connecting the noise attenuator to a second electrical connector, the second electrical connector configured and adapted to hand connect to and hand disconnect from an active noise reduction earphone;
wherein the noise attenuator is configured and adapted to attenuate noise in an electrical signal received from the first electrical connector and transmit the attenuated electrical signal to the second electrical connector.

18. The method of claim 17, comprising:
connecting a first amplifier to the first electrical connector and the second electrical connector, the first amplifier configured and adapted to amplify an electrical signal received from the first electrical connector and transmit the amplified electrical signal to the second electrical connector.

19. The method of claim 17, comprising:
connecting a second amplifier to a third electrical connector, the third electrical connector configured and adapted to hand connect to and hand disconnect from a microphone; and
connecting the second amplifier to a fourth electrical connector, the fourth electrical connector configured and adapted to hand connect to and hand disconnect from an aircraft communication system;
wherein the amplifier is configured and adapted to amplify an electrical signal received from the third electrical connector and transmit the amplified signal to a fourth electrical connector.

20. The method of claim 19, wherein the second and third electrical connectors are portions of the same electrical plug or receptacle.
